(19) United States
(12) Patent Application Publication
(10) Pub. No.: US 2011/0231698 A1
(43) Pub. Date: Sep. 22, 2011

(54) BLOCK BASED VSS TECHNOLOGY IN WORKLOAD MIGRATION AND DISASTER RECOVERY IN COMPUTING SYSTEM ENVIRONMENT

(76) Inventors: Andrei C. Zlati, North York (CA); Ari B. Glaizel, Vaughan (CA); Arthur Amshukov, Oakville (CA)

(21) Appl. No.: 12/728,351

(22) Filed: Mar. 22, 2010

(51) Int. Cl. G06F 11/14; G06F 12/00; G06F 12/16; G06F 11/00

(52) U.S. Cl. 714/3; 711/162; 714/E11.122; 711/E12.001; 711/E12.103; 714/47.1

(57) ABSTRACT

Methods and apparatus involve migrating workloads and disaster recovery. A snapshot is taken of a source volume using a volume shadow service. Depending whether a user seeks a migration or disaster recovery action, blocks of data read from the snapshot are transferred to a target volume in various amounts. The amounts of transfer include all of the blocks, only changed blocks between the volumes, or only blocks incrementally changed since a last transfer operation. Users make indications for transfer on a computing device storing and consuming data on the volumes and optionally do so in the context of Novell's Platespin® products. Other features contemplate kernel drivers to monitor the blocks of the volumes, as well as techniques for comparing them. Still other features involve computing systems, volume devices, such as readers, writers and filters, and computer program products, to name a few.

### FIELD OF THE INVENTION

Generally, the present invention relates to computing devices and environments involving virtual and physical machines. Particularly, although not exclusively, it relates to migrating workloads in such environments and recovering them in situations involving disasters or other phenomenon. Further embodiments contemplate computing systems, drivers, volume devices, such as readers, writers and filters, and computer program products, to name a few.

### BACKGROUND OF THE INVENTION

In a computing system environment, many factors have been long known for ensuring the success and reliability of workload migration and disaster recovery operations. In any workload transfer, many different customer environments must be contemplated, including LAN, WAN, etc., latency, packets lost, network speed, and the like. The duration of the transfer operation is also important to the transfer's success or not. If the available network is considered fast and reliable, disk read/write operations then become a possible bottleneck in quick/reliable transfers. As it presently exists, a file-based transfer does not take full advantage of network speeds and makes the duration of the operation dependent on file system properties such as file fragmentation, count, and size. Alternatively, if the network for the workload transfer is considered unreliable, such as with networks having considerable latency and/or high packet loss, then it is the network itself that becomes the bottleneck in the transfer's success. In such situations, the only seeming way to reduce the transfer duration is to reduce the volume of the data being sent. Such is impractical for certain transfers, especially during disaster recovery operations having expansively large workloads.

Accordingly, a need exists in the art for better migrating and recovering workloads. The need further extends to contemplating various transfer and recovery techniques as a function of customer and network environments, including LAN, WAN, etc., latency, packet transfer rates, network speed, and the like. The duration of the transfer operation is also an important consideration. Good engineering practices are omnipresent as well, such as simplicity, ease of implementation, unobtrusiveness, security, stability, etc.

### SUMMARY OF THE INVENTION

By applying the principles and teachings associated with block-based Volume Snapshot Service or Volume Shadow copy Service (VSS) technology, used interchangeably, in a computing system environment, the foregoing and other problems become solved. Broadly, methods and apparatus involve migrating workloads and recovering data after disasters or other phenomenon.

During use, a snapshot of a workload source volume is taken using a volume shadow service. Then, depending upon whether a user seeks a migration or disaster recovery action, blocks of data read from the taken snapshot are transferred to a workload target volume in various amounts. The amounts are either all of the blocks of data read from the taken snapshot for a full replication between the volumes, only changed blocks of data between the volumes for a delta replication, or only blocks of data changed from a last transfer operation for an incremental replication. Users make indications on a computing device storing and consuming data on the volumes by selecting “Full,” “Server Synch.” and “Incremental Synchronization” actions in Novell's Platespin® product, for example. They indicate their preference for types of transfer based on “One-Time Migration” and “Protection” operations in the same Platespin® products.

Kernel drivers are also configured for installation on a computing device to monitor the blocks of data of the volumes. In one embodiment, the driver records changes as a bitmap file on the source volume and transfers incremental changes to the target volume. In the event the driver fails, fallback transferring of blocks of data includes delta transfers of changed blocks of data, such as during a “server synch” operation. Still other embodiments contemplate comparing blocks of data between the volumes, such as by hashing routines or functions, in order to determine delta replications from the source to the target. Other features contemplate computing systems, drivers, and volume devices, such as readers, writers and filters, to name a few.

In a representative embodiment of migration, a workload is “one-time” migrated from a source workload to a target workload. It occurs as a “Full” transfer operation, where the source workload is fully replicated to the target workload. Alternatively, it occurs as a “Server Sync” operation where only the blocks that are different between the volumes are replicated from the source to the target.

In a representative embodiment of disaster recovery, or protection, a protection contract is defined and includes the following high-level notions:

Initial Setup, whereby a kernel filter driver is installed on a computing device that monitors the volume changes on the source volume;

Initial Copy, whereby the source workload is replicated to the target workload as a full transfer or server synchronization. The state of the driver is reset at the beginning of this copy and the changes to the volumes are recorded; and

Incremental Copy, whereby transfer occurs between the volumes as scheduled events or operations. In one example, only the changes recorded since a last incremental copy (or the initial copy if it is the first incremental copy) are replicated from the source to the target. In this embodiment, the driver state is also reset if the incremental copy is successful. However, if the driver malfunctions, the incremental operation will be defaulted back to “Server Synchronization” transfer. The incremental operation is executed until the contract is stopped or paused.

Executable instructions loaded on one or more computing devices for undertaking the foregoing are also contemplated, as are computer program products available as a download or on a computer readable medium. The computer program products are contemplated for installation on a network appliance or an individual computing device. They can be used in and out of computing clouds as well.

Certain advantages realized by embodiments of the invention include, but are not limited to: better migration and recovery techniques in comparison to the prior art; contemplating transfer and recovery techniques as a function of customer and network environments, including LAN, WAN, etc., latency, packet transfer rates, network speed, and the like; and consideration of duration of the transfer operation.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a basic computing device hosting virtual machines, including a network interface with other devices;

FIG. 2 is a diagrammatic view in accordance with the present invention for a controller architecture hosting executable instructions;

FIG. 3 is a flow chart in accordance with the present invention for an embodiment of block based VSS technology for migrating and recovering workloads between volumes;

FIG. 4 is a diagrammatic view in accordance with the present invention for an embodiment showing various data filters for use in block based VSS technology for migrating and recovering workloads between volumes;

FIG. 5 is a flow chart in accordance with the present invention for an embodiment of server synchronization block based VSS technology for migrating and recovering workloads between volumes; and

FIG. 6 is a combined diagrammatic view and flow chart in accordance with the present invention for an embodiment using a kernel driver in block based VSS technology for migrating and recovering workloads between volumes.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus are hereinafter described for block-based VSS technology in migrating and recovering workloads in a computing system environment with physical and/or virtual machines.

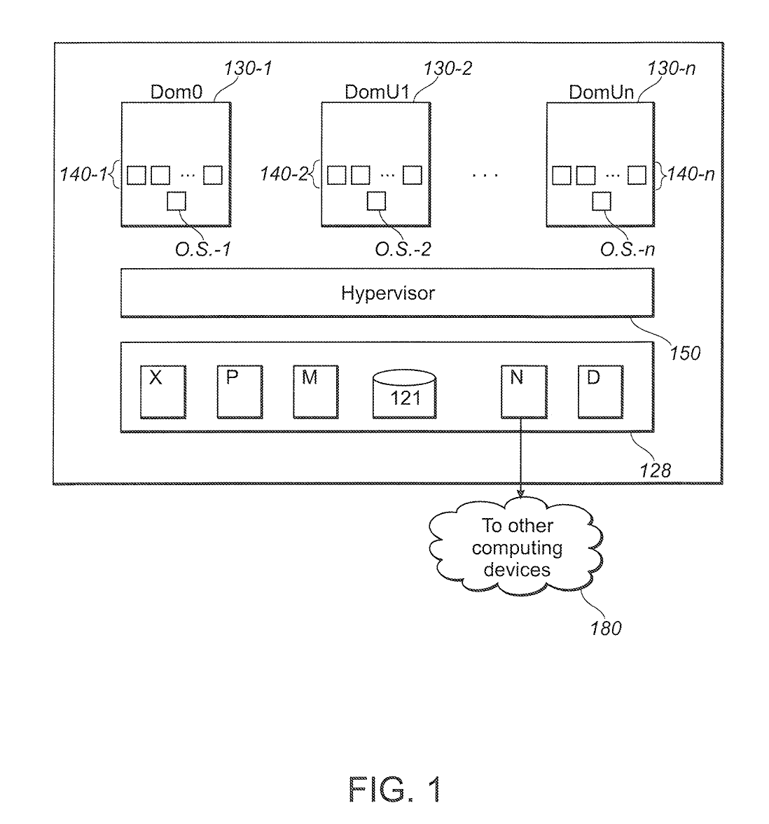

With reference to FIG. 1, a computing system environment 100 includes a computing device 120. Representatively, the device is a general or special purpose computer, a phone, a PDA, a server, a laptop, etc., having a hardware platform 128. The hardware platform includes physical I/O and platform devices, memory (M), processor (P), such as a physical CPU(s) or other controller(s), USB or other interfaces (X), drivers (D), etc. In turn, the hardware platform hosts one or more guest virtual machines in the form of domains 130-1 (domain 0, or management domain), 130-2 (domain UI), . . . 130-n (domain Un), each potentially having its own guest operating system (O.S.) (e.g., Linux, Windows, Netware, Unix, etc.), applications 140-1, 140-2, . . . 140-n, file systems, etc. The workloads of each virtual machine also consume data stored on one or more disks or other volumes 121.

An intervening Xen, Hyper V, KVM, VmWare or other hypervisor 150, also known as a “virtual machine monitor,” or virtualization manager, serves as a virtual interface to the hardware and virtualizes the hardware. It is also the lowest and most privileged layer and performs scheduling control between the virtual machines as they task the resources of the hardware platform, e.g., memory, processor, storage, network (N) (by way of network interface cards, for example), etc. The hypervisor also manages conflicts, among other things, caused by operating system access to privileged machine instructions. The hypervisor can also be type 1 (native) or type 2 (hosted). According to various partitions, the operating systems, applications, application data, boot data, or other data, executable instructions, etc., of the machines are virtually stored on the resources of the hardware platform.

In use, the representative computing device 120 is arranged to communicate 180 with one or more other computing devices or networks. In this regard, the devices may use wired, wireless or combined connections to other devices/networks and may be direct or indirect connections. If direct, they typify connections within physical or network proximity (e.g., intranet). If indirect, they typify connections such as those found with the internet, satellites, radio transmissions, or the like. The connections may also be local area networks (LAN), wide area networks (WAN), metro area networks (MAN), etc., that are presented by way of example and not limitation. The topology is also any of a variety, such as ring, star, bridged, cascaded, meshed, or other known or hereinafter invented arrangement.

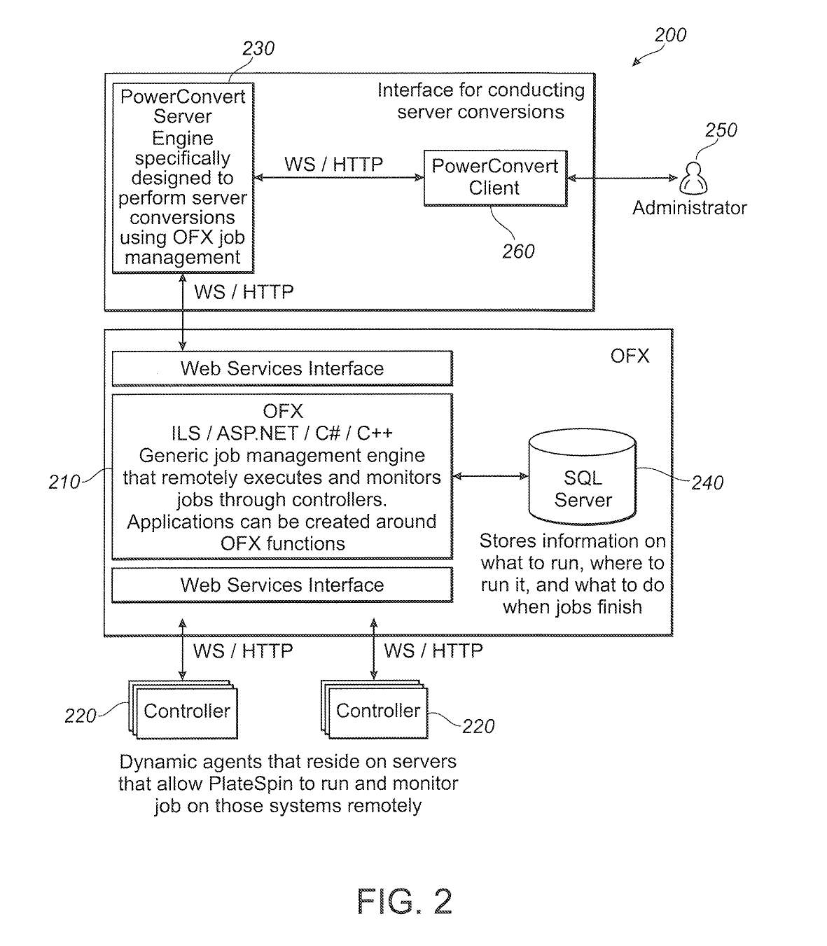

With the foregoing as backdrop, FIG. 2 shows a controller architecture 200 presently in use in Novell's PlateSpin® product. As is known, the PlateSpin product utilizing PlateSpin Forge is a consolidated recovery hardware appliance that protects both physical and virtual server workloads using embedded virtualization technology. In the event of a production server outage or disaster, workloads can be rapidly powered on in the PlateSpin Forge recovery environment and continue to run as normal until the production environment is restored. It is designed for use to protect between 10 and 25 workloads and ships pre-packaged with Novell, Inc.'s, storage, applications and virtualization technology. In design, an OFX controller 210 of the architecture is installed on a computing device and acts as a job management engine to remotely execute and monitor recovery and migration jobs by way of other controllers 220.

In other regards, a virtual machine may be moved to a physical machine or vice versa. Conversions may also be performed with images. (An image is a static data store of the state of a machine at a given time.) All conversions are achieved by pushing a job containing information on the actions to be performed to the OFX controller. A controller resides on the machine where the actions take place and executes and reports on the status of the job. (For a more detailed discussion of the controller and computing environment, reference is taken to U.S. Patent Publication 2006/0089995. Such is also incorporated herein, in its entirety, by reference.) The controller also communicates with a PowerConvert product server 230 and an SQL server 240.

The latter, also known as a server in a “Structured Query Language,” is a relational database management system having data query and updates, schema creation and modification, and data access control. Generically, it stores information on what jobs to run, where to run them and what actions to take when finished. The former is a powerful enterprise-ready workload portability and protection solution from Novell, Inc. It optimizes the data center by streaming server workloads over the network between physical servers, virtual hosts and image archives. The PowerConvert feature remotely decouples workloads from the underlying server hardware and streams them to and from any physical or virtual host with a simple drag and drop service. In this regard, the controllers 220 serve as dynamic agents residing on various servers that allow the PlateSpin product to run and monitor jobs. A system administrator 250, by way of a PowerConvert client 260, interfaces with the server 240 to undertake installation, maintenance, and other computing events known in the art. Also, the OFX controller interfaces with common or proprietary web service interfaces 270 in order to effectively bridge the gap of semantics, or other computing designs, between the controllers 220 and server 240.

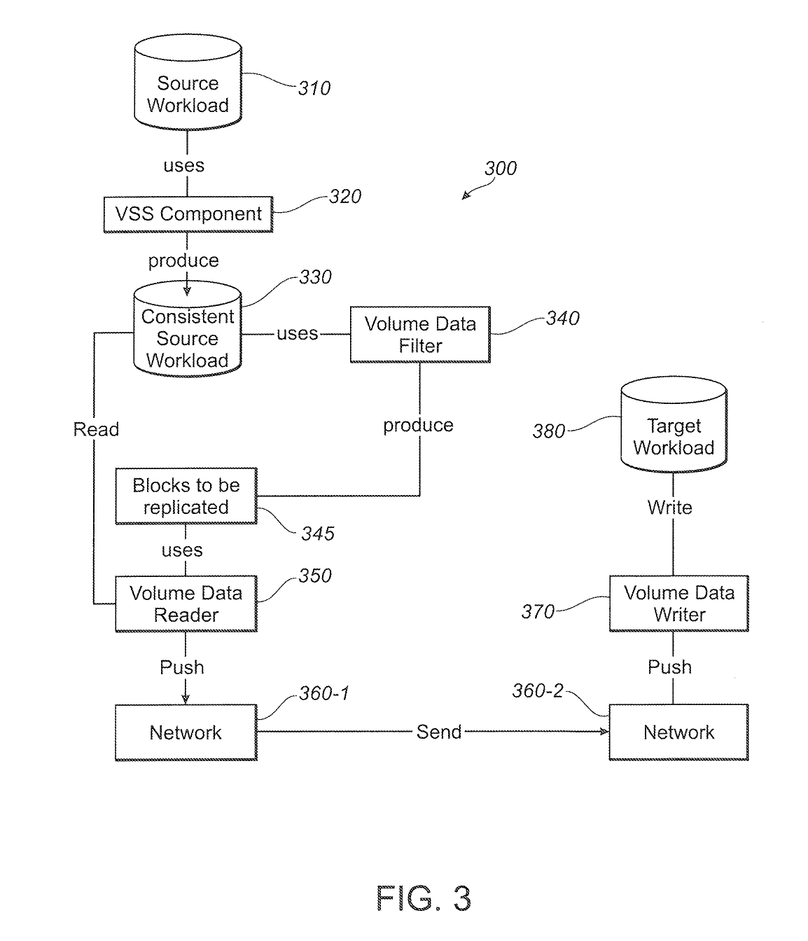

Associated with the OFX controller are executable instructions that undertake the functionality of FIG. 3. At a high level, the functionality 300 leverages Block Based VSS as a core technology for workload transfer, including operations of “Full,” “Server Sync” and “Incremental Synchronization.” The transfer component is used in both migration and recovery operations in the PlateSpin product (representatively) as “One Time Migration” and “Protection” operations, for instance.

In “One Time Migration,” the source workload is replicated one time to the target workload. This can be either a “Full” operation where the source workload is wholly or fully replicated to the target workload or it can be a “Server Sync” operation where only the blocks that are different between the volumes are replicated from the source to the target.

In a “Protection” operation, a protection “contract” is entered by user agreement and has the following major components:

Initial Setup, whereby a kernel filter driver is installed on a computing device that monitors the volume changes on the source volume;

Initial Copy, whereby the source workload is replicated to the target workload as a full transfer or server synchronization. The state of the driver is reset at the beginning of this copy and the changes to the volumes are recorded; and

Incremental Copy, whereby transfer occurs between the volumes as scheduled operations. In one example, only the changes recorded since a last incremental copy (or the initial copy if it is the first incremental copy) are replicated from the source to the target. In this embodiment, the driver state is also reset if the incremental copy is successful. However, if the driver malfunctions, the incremental operation will be defaulted back to “Server Synchronization” transfer. The incremental operation is executed until the contract is stopped or paused.

With continued reference to FIG. 3, the illustrated components are used to describe the architecture of the transfer workload module.

At 310, a source workload is stored on a computing volume, such as a disk. At a given point in time, such as upon a request from a user for a transfer operation, at start-up, after reboot, or the like, a VSS Component 320 creates a snapshot of the volume. The snapshot process is transactional for all volumes which ensures application consistency and volume consistency across the workload. Also, the VSS Component produces a consistent source workload view at 330 for the workload at the time the snapshot was taken, and this consistent view becomes the input for volume devices, such as the Volume Data Filter 340 and Volume Data Reader 350 components.

During use, the Volume Data Reader 350 reads the blocks of data specified from a source NTFS volume at the volume level. However, the “System Volume Information” folder and the page file are excluded from the input blocks. The Volume Data Writer 370 writes these same read blocks of data to a target NTFS volume 380 at the volume level. Both the Volume data reader and writer interact with Network Components 360-1, 360-2.

In turn, the network component are responsible to send and receive the data from the read blocks of the source 330 to the target workload 380. The component is highly optimized for any type of network, LAN, WAN, etc. with considerations given for latency, packet transfer success, and speed (fast Gb) networks.

At 340, the Volume Data Filter interacts with the Volume Data Reader. It specifies to the reader what blocks need to be replicated 345 at the target workload and, therefore, need to be read from the source by the reader at 350. There are three types of filters, one for each type of protection operation.

1. Full Filter—the blocks returned by this filter include the entirety of all the allocated clusters from an NTFS volume—sending FSCTL_GET_VOLUME_BITMAP control codes to the device retrieves the usage bitmap for the volume. This type of filter is used in a “full” migration type operation.

2. Server Sync Filter—the context for this type of filter is related to both the source and target volumes, such that only the blocks that are different between one another on the volumes will be returned by the filter. The comparison to determine differences between the volumes is undertaken via a hashing function for a given block of data. Of course, other comparison schemes may be used.

3. Incremental Synchronization Filter—only the blocks that have changed since a last synchronization operation will be returned by the filter from the source volume. In this regard, a volume kernel filter driver is installed on a computing device as an initial setup for a Protection Contract. The driver interacts with the OFX controller to record the changes at the volume level. After each operation, the kernel state is reset.

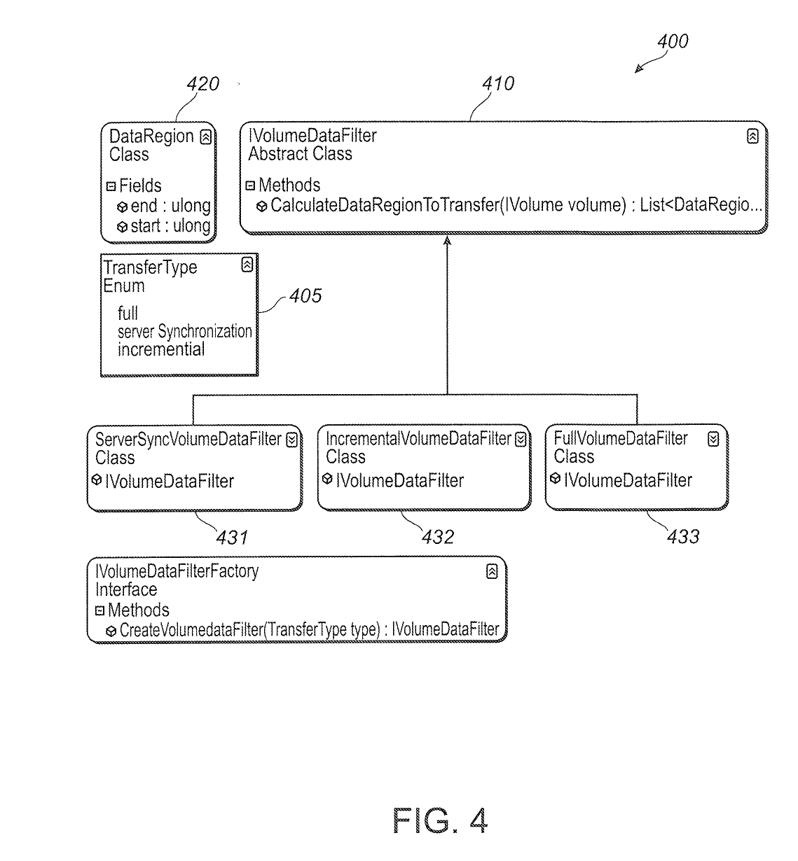

With reference to FIG. 4, class diagrams 400 describe the software design for creating a generic filter in a PlateSpin® product based on the type of transfer operation 405. At 410, the IVolumeDataFilterFactory is responsible for creating the concrete implementation 431, 432, 433 of the Volume Data Filter, based on the transfer type. The concrete implementation returns a list of “Data Region” elements 420 when a routine of CalculateDataRegionToTransfer is invoked.

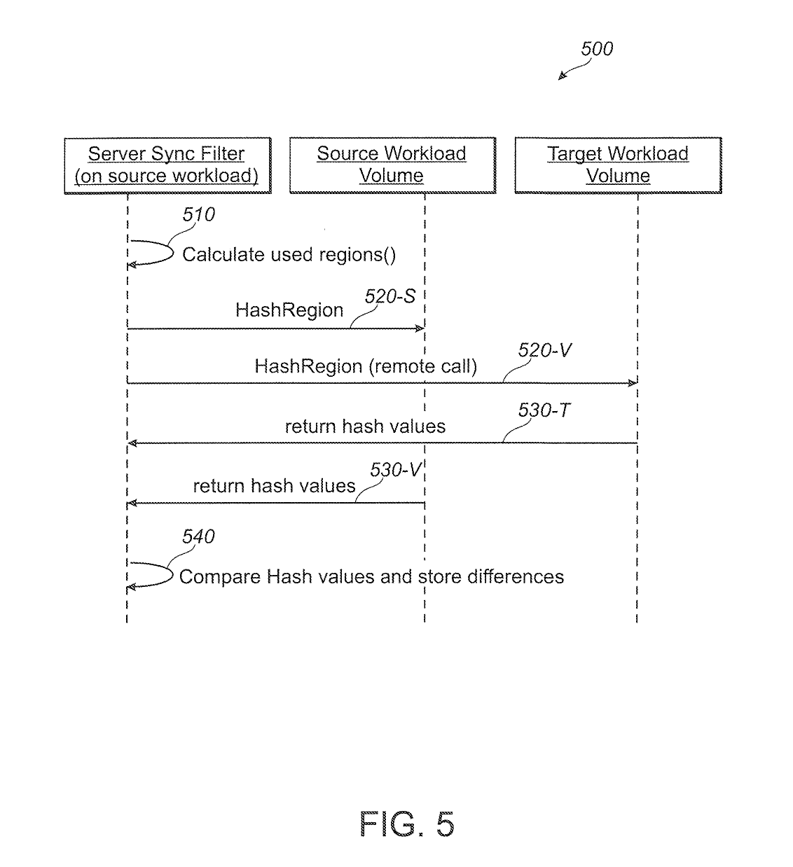

With reference to FIG. 5, an architecture 500 of the Server Sync Filter on the source workload is given. At 510, a call to hash the regions from both the source and target volumes is done in parallel to use the resources from both workloads. The HashRegion operation 520-S, 520-T is highly optimized to parallelize the disk 10 and the calculation of the hash function. At 530-S, 530-T, the hash values are returned to the filter. The filter at 540 then compares the values, stores them, and notes the differences. The blocks of data defining the differences are eventually transferred from the source to the target. The size of the blocks to be compared is configurable by users at runtime. A good default value is 64K. To the extent a smaller value is used, less bandwidth can be consumed but with more controller processing (and vice versa for larger values). Also, the number of blocks to be hashed at one time is configurable by users and defined at runtime.

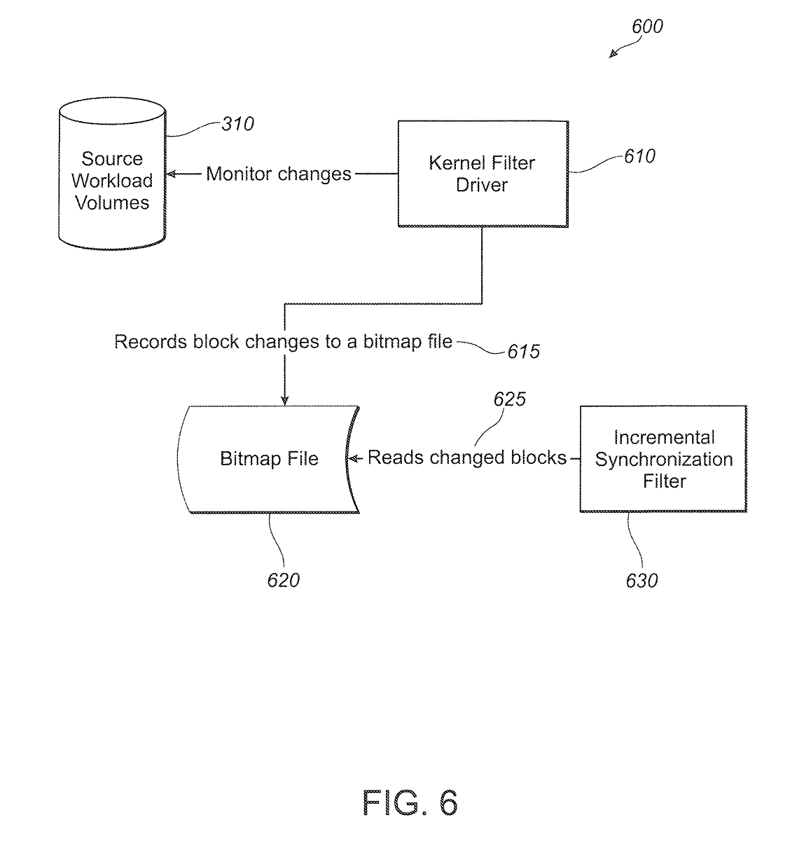

With reference to FIG. 6, an architecture 600 describes the Incremental Synchronization Filter. At 610, the Kernel Filter Driver is created to keep track of the changes on the source volume between incrementals. During an incremental transfer operation, the driver records a list of blocks changed since a last synchronization operation at 615. This list is stored as a bitmap on the source volume at 620. During a copying step, by the filter 630, only changed blocks are copied from the bitmap 625 on the source volume snapshot for transfer to the target. However, the driver is monitored to see if it is operating properly. If not (e.g., malfunctioning), the incremental job reverts from the incremental to a server sync mode of operation. In this situation, all differences between the volumes are identified and transferred as in the server sync situation above.

As a result, the foregoing scheme provides the following:

1. The Block Based Server Sync feature in the PlateSpin product has been observed to provide a major differentiation over competitors that helps customers save time and money when implementing Disaster Recovery Solutions. In a traditional disaster recovery solution, the source is repeatedly fully replicated at the target. The solution here, however, involves a full migration using a local fast network, deploying the target to the disaster recovery site, and then protecting later transfers with a “Block Based Server Sync” operation that sends but the differences to the target. This reduces time and load on the network.

If the protected workload goes down, the virtual machine can be up and running within minutes using failover functionality not found in traditional backup tools. And when fallback occurs, the replacement server can be a different model or brand than the original physical server. If the original server can be repaired, “Block Based Server Sync” technology can make the fallback process faster by copying back only the changes that occurred after the failover, rather than copying back the entire workload.

2. The architecture, design and the implementation of the software is unique, robust and scalable making our Protection solution unique in the market space. For example, it includes:

Robustness—a kernel mode unexpected fault can cause the machine to crash or hang—for that reason, the kernel driver implementation of the present embodiments is intentionally very simple and the role of the driver is very strictly defined to just monitor the changes to the volumes. This adds robustness by eliminating unnecessary routines that run in kernel mode. The device IO operation and the network library are entirely running in user mode.

Fallback solutions—if the driver is malfunctioning, the incremental job falls back to “Block Based Server Sync.” In this case, all differences are identified and transferred as in the server sync case.

Scalability—the computer resources (Processor, Disk, and Network) that the software needs to run are used in an optimal manner—always, only the slowest resource will be the bottleneck in the system.

Also, embodiments of the present invention can be applied to solve different problems. For example:

1. During a conventional protection contract, the virtual target workload needs to be live in order to complete a replication. This adds a resource overhead to the server hosting the virtual target workload. With the present solution, there is no need to understand the target workload files system and operating system as operation occurs at the binary block level—any operation can be done writing directly to the files hosting the virtual target workload.

2. Using the “Block Based Server Sync” mechanism, the invention can synchronize workloads from any two machines, leaving the traditional file synchronization alone for a much faster and reliable solution.

In still other embodiments, skilled artisans will appreciate that enterprises can implement some or all of the foregoing with the assistance of system administrators acting on computing devices by way of executable code. In turn, methods and apparatus of the invention further contemplate computer executable instructions, e.g., code or software, as part of computer program products on readable media, e.g., disks for insertion in a drive of computing device, or available as downloads or direct use from an upstream computing device. When described in the context of such computer program products, it is denoted that items thereof, such as modules, routines, programs, objects, components, data structures, etc., perform particular tasks or implement particular abstract data types within various structures of the computing system which cause a certain function or group of function, and such are well known in the art.

The foregoing has been described in terms of specific embodiments, but one of ordinary skill in the art will recognize that additional embodiments are possible without departing from its teachings. This detailed description, therefore, and particularly the specific details of the exemplary embodiments disclosed, is given primarily for clarity of understanding, and no unnecessary limitations are to be implied, for modifications will become evident to those skilled in the art upon reading this disclosure and may be made without departing from the spirit or scope of the invention. Relatively apparent modifications, of course, include combining the various features of one or more figures with the features of one or more of the other figures.

1. A method of migrating computing workloads or undertaking disaster recovery in a computing system environment, comprising:
taking a snapshot of a workload source volume using a volume shadow service;
determining a filtering action for the workload migration or disaster recovery according to a user selection; and
transferring to a workload target volume blocks of data read from the taken snapshot in an amount based on the determined filtered action.

2. The method of claim 1, wherein the transferring blocks of data further includes transferring from the workload source volume to the workload target volume all of the blocks of data said read from the taken snapshot.

3. The method of claim 1, wherein the transferring blocks of data further includes transferring from the workload source volume to the workload target volume only a delta of the blocks of data said read from the taken snapshot indicating only changed blocks between said volumes.

4. The method of claim 1, wherein the transferring blocks of data further includes transferring from the workload source volume to the workload target volume only blocks of data changed from a last operation after the taken snapshot.

5. The method of claim 1, further including determining whether the user selection relates to the workload migration or the disaster recovery.

6. The method of claim 1, further including configuring a kernel driver for installation on a computing device to monitor the blocks of data on said volumes.

7. The method of claim 6, further including monitoring malfunctions of the kernel driver.

8. The method of claim 7, further including transferring from the workload source volume to the workload target volume when the kernel driver is determined to have said malfunctioned only a delta of the blocks of data said read from the taken snapshot indicating only changed blocks between said volumes.

9. The method of claim 1, further including comparing the blocks of data said read from the taken snapshot to blocks of data on the workload target volume.

10. The method of 9, wherein the comparing further includes undertaking a hashing function for given blocks of the blocks of data.

11. The method of claim 4, further including storing the only blocks of data changed from the last operation as a bitmap on the workload source volume.

12. A method of migrating computing workloads or undertaking disaster recovery in a computing system environment, comprising:
taking a snapshot of a workload source volume using a volume shadow service;
determining whether a user of a computing device seeks data services for the workload migration or disaster recovery;
determining a filtering action of the user per each of the workload migration or disaster recovery; and
transferring to a workload target volume blocks of data read from the taken snapshot in an amount based on the determined filtered action.

13. The method of claim 12, wherein the transferring blocks of data further includes transferring all of the blocks of data said read from the taken snapshot if the determined filtering action is a full replication of the workload source volume to the workload target volume and the determined data services is for either the workload migration or disaster recovery.

14. The method of claim 12, wherein the transferring blocks of data further includes transferring only a delta of the blocks of data said read from the taken snapshot if the determined filtering action is a server synch selection whereby only changed blocks of the workload source volume are replicated to the workload target volume.

15. The method of claim 12, wherein the transferring blocks of data further includes transferring from the workload source volume to the workload target volume only blocks of data changed since a last operation of block transfer between the volumes after the taken snapshot.

16. The method of claim 15, further including configuring a kernel driver for installation on the computing device to monitor the blocks of data on said volumes.

17. The method of claim 16, further including monitoring malfunctions of the kernel driver.

18. The method of claim 17, further including transferring from the workload source volume to the workload target volume when the kernel driver is determined to have said malfunctioned only a delta of the blocks of data said read from the taken snapshot indicating only changed blocks between said volumes.

19. The method of claim 16, further including storing the only blocks of data changed from the last operation as a bitmap on the workload source volume.

20. A method of migrating computing workloads or undertaking disaster recovery in a computing system environment, comprising:
taking a snapshot of a workload source volume using a volume shadow service;
receiving indication from a user of a computing device storing data on the workload source volume whether the user seeks data services for the workload migration or the disaster recovery;
receiving indication from the user whether the sought data services are for a full replication, a delta replication or an incremental replication per the received indication of the workload migration or the disaster recovery; and
transferring from the workload source volume to a workload target volume blocks of data read from the taken snapshot in an amount corresponding to all of the blocks of data said read from the taken snapshot for the full replication, only changed blocks of data between the volumes for the delta replication, or only blocks of data changed from a last transfer after the taken snapshot for the incremental replication.
